(19) United States
(12) Patent Application Publication
(10) Pub. No.: US 2009/0020017 A1
(43) Pub. Date: Jan. 22, 2009

(54) Coffee Maker

(75) Inventors: Kuohsun Lin, Ren Teh Hsiang (CN); Shengfang Cheng, Anding Hsiang (TW)

Correspondence Address: KENING LI;PINSENT MASONS, c/o BAKER DONELSON BEARMAN CALDWELL& BERKOWITZ, PC, 555 ELEVENTH STREET, NW, SIXTH FLOOR, WASHINGTON, DC, 20004, US

(73) Assignee: TSANN KUEN (CHINA) ENTERPRISE CO., LTD., Fujian (CN)

(21) Appl. No.: 12/163,250

(22) Filed: Jun. 27, 2008

(30) Foreign Application Priority Data
Jun. 28, 2007 (CN) 200720007485.2

(51) Int. Cl. A47J 31/44; A47J 31/50

(52) U.S. Cl. 99/284

(57) ABSTRACT

A coffee maker disclosed in the present invention at least comprises a supporting device, a brewing device, a heating device, an insulated carafe containing magnet, a magnetism-detecting device and a control device. The supporting device is used for supporting a carafe. The heating device is used for providing the hot water for brewing the coffee for the brewing device, and it can heat the carafe supported by the supporting device selectively. The insulated carafe containing magnet mounted detachably on the supporting device. The magnetism-detecting device is used for detecting the carafe supported by the supporting device whether it contains magnet or not, thus judges the carafe is an insulated carafe containing magnetic or not. The control device is connected to the magnetism-detecting device and the heating device, it estimate whether it need to heat the carafe supported by the supporting device or not based on the detecting result of the magnetism-detecting device.

### FIELD OF THE INVENTION

The present invention relates to coffee makers and, more particularly, to a coffee maker capable of auto-recognizing the insulated carafe and uninsulated carafe, and it can heat the uninsulated carafe to maintain the optimal temperature of coffee in a determined time, while the insulated carafe is thermally-insulated, it can auto cut-off the heating device.

### BACKGROUND OF THE INVENTION

Generally coffee makers comprise a body for brewing coffee and a carafe for containing coffee. The carafes usually can be divided into thermally-insulated carafes and uninsulated carafes. When using the insulated carafe for containing the coffee, it does not need to provide additional heat to maintain the temperature of the coffee in the carafe. When using the uninsulated carafe, it must provide additional heat to the carafe to maintain the temperature of the coffee, so as to insure the flavor and taste of the coffee.

U.S. Pat. No. 6,279,459 disclosed a coffee maker capable of auto-recognizing the insulated carafe and uninsulated carafe. When the users place the carafes onto the coffee maker, it will automatically detect the carafe as being an insulated carafe or an uninsulated carafe, then the coffee maker will auto-determine to either heat or not heat the coffee in the carafe. This coffee maker capable of auto-recognizing a carafe is more convenient in operation compared with a traditional coffee maker, so it is well accepted by the consumers.

This coffee maker capable of auto-recognizing the insulated carafe and the uninsulated carafe must mount two different heating systems to heat the water for brewing coffee and the coffee in the uninsulated carafe respectively. In another aspect, for this coffee maker to recognize the insulated carafe or uninsulated carafe by the difference of the carafe's structure, the structure of the coffee maker must be equipped with a mechanical contact sensor. Thus, it is not convenient in cleaning and the mechanical contact sensor affects the outer shape of the coffee maker. Therefore, it is inconvenient to clean when used by the consumer and can not meet the actual requirement of the consumer.

### SUMMARY OF THE INVENTION

The present invention provides a coffee maker which overcomes the aforementioned problems existing in the coffee maker capable of auto-recognizing the insulated carafe and uninsulated carafe in the background art which has a high manufacture cost, a lack of ease in cleaning and limited shape design.

The above and other objects of the invention are achieved by providing a coffee maker at least comprising a supporting device, a brewing device, a heating device, an insulated carafe containing magnet, a magnetism-detecting device and a control device. Herein the supporting device is used for supporting a carafe. The heating device is used for providing the hot water for brewing the coffee for the brewing device. Herein the heating device can heat the carafe supported by the supporting device selectively. The insulated carafe containing magnet is mounted detachably on the supporting device. The magnetism-detecting device is used for detecting the carafe supported by the supporting device whether it contains a magnet or not, thus estimate the carafe is an insulated carafe containing or not containing a magnet. The control device is connected to the magnetism-detect device and the heating device, herein the control device judges whether it needs to heat the carafe supported by the supporting device or not based on the detecting result of the magnetism-detecting device. If the carafe supported by the supporting device has magnetism, the heating device will not heat the carafe.

According to one preferred embodiment of the present invention, further comprises at least an uninsulated carafe without magnetism, which mounted on the supporting device detachably.

According to one preferred embodiment of the present invention, the supporting device has a warming plate for supporting the carafe.

According to one preferred embodiment of the present invention, the heating device is under the warming plate.

According to one preferred embodiment of the present invention, the supporting device has a cavity for containing the carafe, and the width of the opening of the cavity is between about half to two-thirds of a circle.

According to one preferred embodiment of the present invention, the heating device mounted in the supporting device.

According to one preferred embodiment of the present invention, the shape of the magnet is an arc.

According to one preferred embodiment of the present invention, the arc of the magnet is between about half to two-thirds of a circle.

According to one preferred embodiment of the present invention, a thermostat is mounted on the side of the heating device.

According to one preferred embodiment of the present invention, the magnet shape is an arc.

The present invention provides a coffee maker capable of auto-recognizing the carafes in a creative way. In one aspect, it uses the common heating system to produce the hot water for brewing coffee and providing heat to maintain the temperature of the coffee in the uninsulated carafe, for that the heating system is shared, so the cost is saved. In another aspect, it designed a magnetic-detection device for recognizing the insulated carafe and uninsulated carafe, owing to the magnetic-detecting way, the detect device needs not contact the shell of the insulated carafe or uninsulated carafe directly, and because the magnetic-detection device is hidden in the shell of the coffee maker, it is overcome the problem of being inconvenient cleaned and limited shape design.

### BRIEF DESCRIPTION OF THE DRAWINGS

The preferred embodiment of the present invention will be described in detail with reference to the drawings and examples:

FIG. 1A is a perspective view of the coffee maker capable of auto-recognizing the carafe in one preferred embodiment of the present invention.

FIG. 1B is a side sectional view of the coffee maker capable of auto-recognizing the carafe in one preferred embodiment of the present invention.

FIG. 1C is a fragmentary exploded view of the coffee maker capable of auto-recognizing the carafe in one preferred embodiment of the present invention.

FIG. 1D is a perspective view of the insulated carafe in one preferred embodiment of the present invention.

FIG. 1E is a perspective view of the uninsulated carafe in one preferred embodiment of the present invention.

FIG. 2A is a front partial sectional view of the coffee maker capable of auto-recognizing the carafe in one preferred embodiment of the present invention.

FIG. 2B is a top partial sectional view of the coffee maker capable of auto-recognizing the carafe in one preferred embodiment of the present invention.

### DETAILED DESCRIPTION OF THE PREFERRED EMBODIMENT

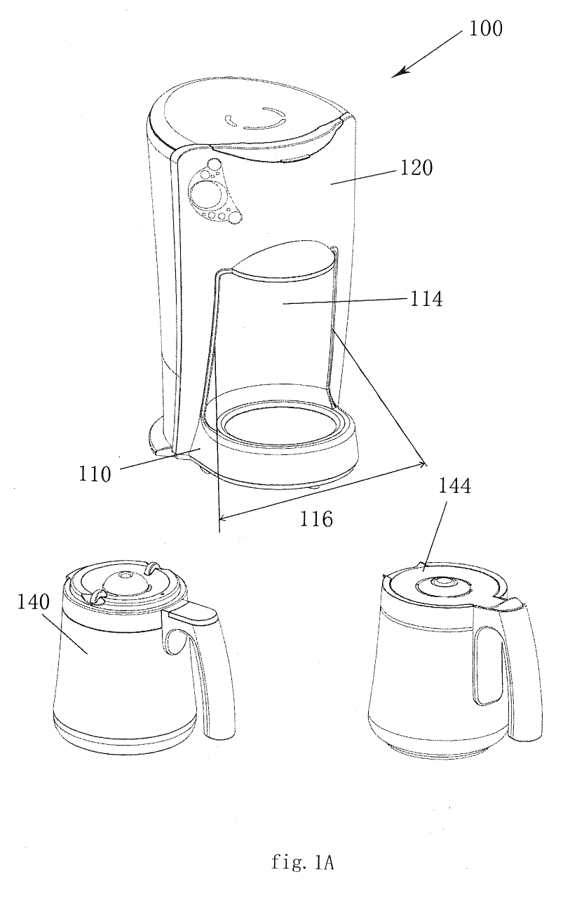

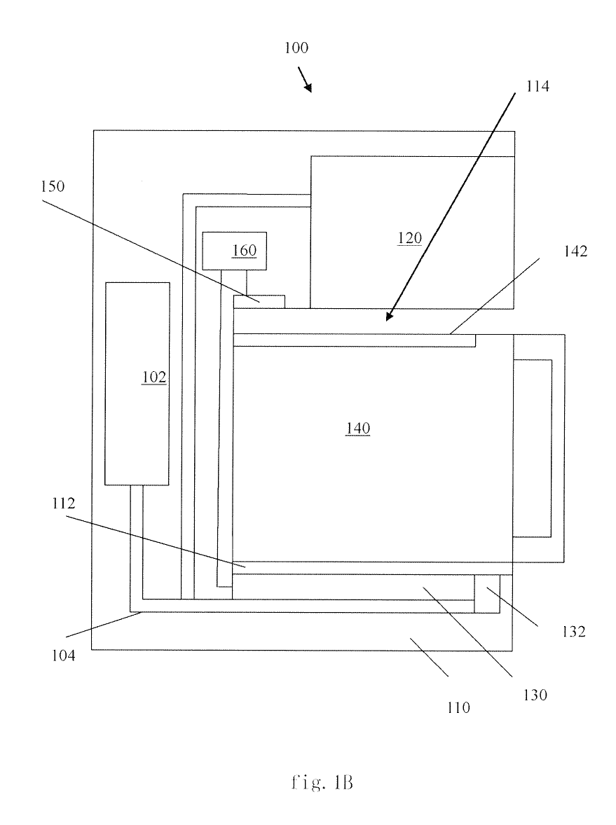

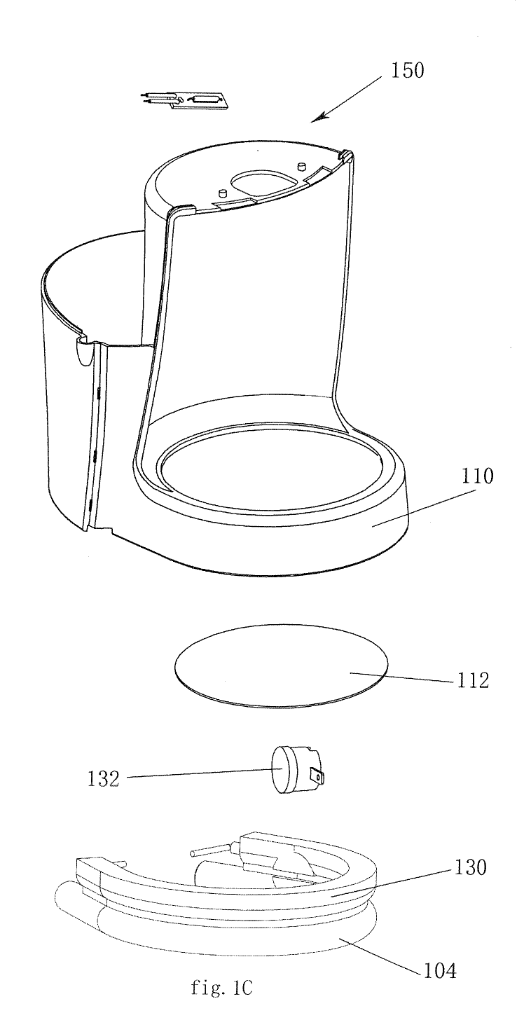

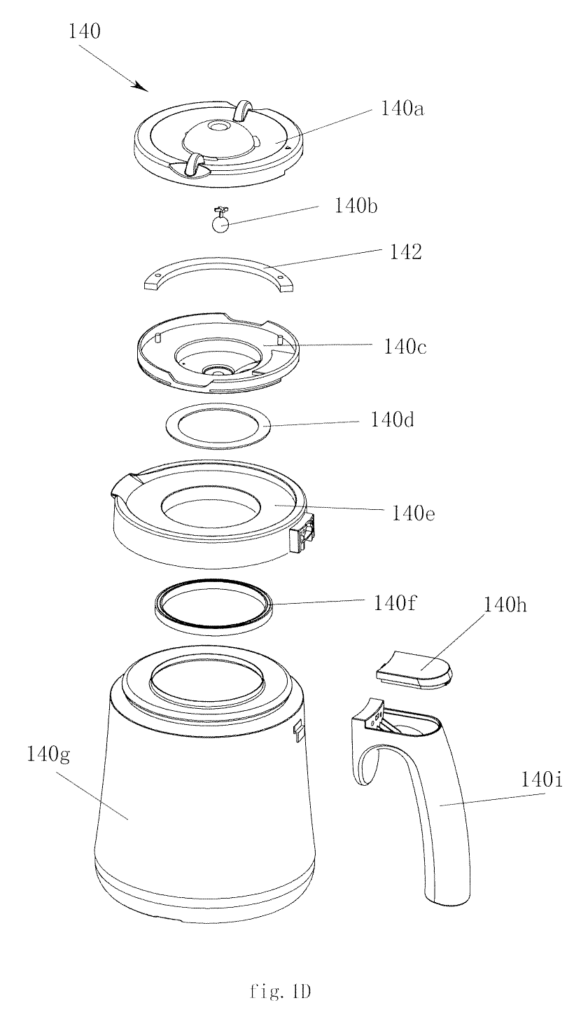

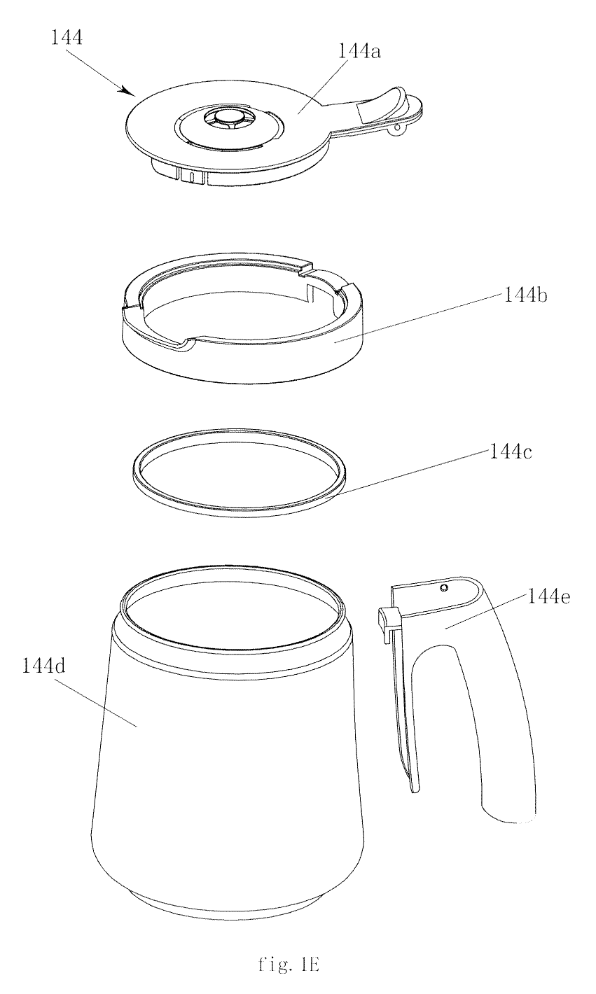

Referring to FIGS. 1A, 1B and 1C, they are a perspective view, a side sectional view, and a fragmentary exploded view of the coffee maker capable of auto-recognizing the carafe in a preferred embodiment of the present invention. The coffee maker 100 comprising a supporting device 110, a brewing device 120, a heating device 130, an insulated carafe 140 which containing magnet 142, a magnetism-detection device 150 and a control device 160, herein the supporting device 110 used for supporting a carafe such as insulated carafe 140 (thermally insulated carafe) or non-magnetic uninsulated carafe 144 (thermally uninsulated carafe). The brewing device 120 is mounted on the supporting device 110 and is used for brewing coffee. The heating device 130 is used for providing the needed hot water for brewing the coffee for the brewing device 120, when the water in water tank 102 transported to the brewing device 120 through the pipe 104, as the heating device 130 is adjacent to the pipe 104, so the water in the pipe 104 can be heated and transported to the brewing device 120 to brew coffee. One character of the present invention is that: the heating device 130 not only used in heating the water which transported to brewing device 120, owing to the heating device 130 mounted in the supporting device 110 and adjacent or connected under the warming plate 112 of the supporting device 110, it also can achieve the aim of heating the carafe on the warming plate 112. In this embodiment there is a thermostat 132 adjacent to the heating device 130 used for detecting the temperature of heating device 130 and controlling the power on/off of the heating device 130, by which the working temperature of heating device 130 can be maintained in certain range. Additionally, this embodiment providing an insulated carafe 140 containing magnet 142 which mounted detachably on the warming plate 112 on the supporting device 110, and a magnetism-detecting device 150 mounted on the coffee maker 110 for detecting whether the carafes on the supporting device 110 is an insulated carafe 140 containing magnet 142 or not, and providing a control device 160 which is connected to the magnetism-detecting device 150 and the heating device 130, the control device 160 responds to the signal from the magnetism-detecting device 150 so as to control the heating device 130 whether to heat the carafe on the supporting device or not. When the insulated carafe 140 containing magnetic 142 is on the supporting device 110, if the magnetism-detecting device 150 detected the magnetic 142 contained in the insulated carafe 140, it will send a signal to control device 160, the control device 160 will respond to the signal and will not provide energy to the thermostat 132, thus the heating device 130 will be cut off and does not heat the carafe supported by supporting device 110. When the uninsulated carafe 144 is on the supporting device 110, the magnetism-detecting device 150 will not detect the insulated carafe 144, the control device 160 will provide energy to the thermostat 132, thus the heating device 130 will be power on and heat the carafe supported by supporting device 110. In this way that the heating device 130 can choose whether heat the carafe supported by supporting device 110 or not. In this embodiment, the magnetism-detecting device 150 is a reed pipe mounted on the shell adjacent to the cavity 114 where the carafe is contained. Referring to FIGS. 1D and 1E, they are perspective views of the insulated carafe 140 and uninsulated carafe 144 in a preferred embodiment of the present invention respectively. The insulated carafe 140 comprises an upper lid 140a, an anti-ball 140b, an arc magnet 142, a swiveling cover 140c, a sealing ring 140d for the swiveling cover, a holder 140e, a carafe sealing ring 140f, carafe body 140g, a handle cover 140h and a handle 140i. As is showed in FIG. 1D, the arc magnet 142 is arranged between the upper lid 140a and the swiveling cover 140c upper to the carafe body 140g. As is showed in FIG. 1E, the uninsulated carafe 144 comprises a lid 144a, a holder 144b, a sealing ring 144c, a carafe body 144d and a handle 144e.

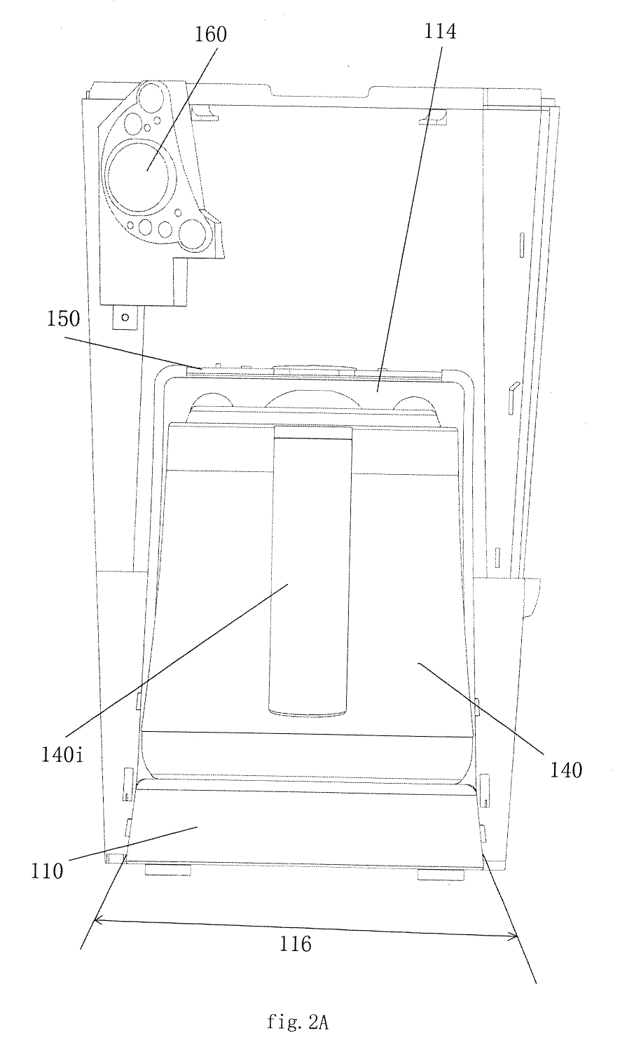

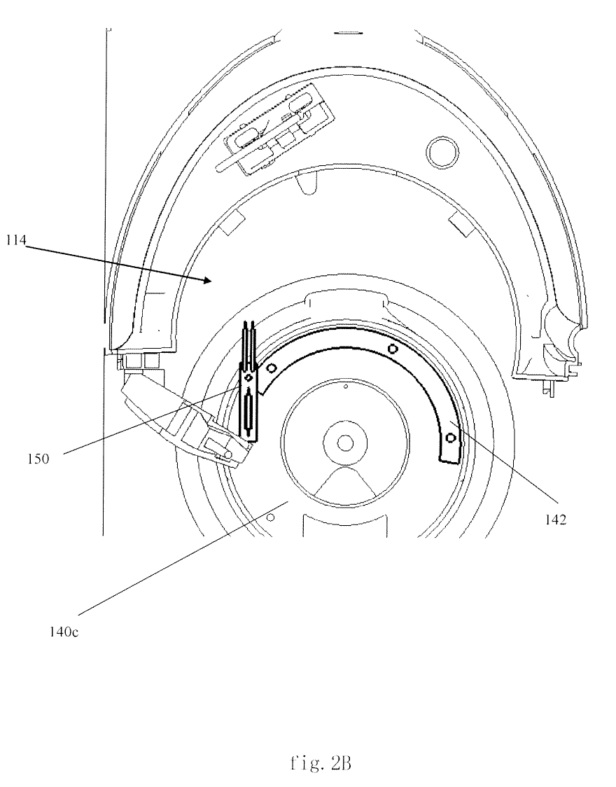

Referring to FIG. 1A, FIGS. 2A and 2B, for the convenience of placing the insulated carafe 140 into the cavity 114 where the carafe contained by the users via the opening 116 of the coffee maker 100, the width of the opening 116 of the carafe-contained cavity 114 is designed between about half to two-thirds of a circle, thus the users can input the carafe 140 to the cavity 114 from various angles by the users. Another character of the present invention is so that the magnet 142 of the carafe 140 can be easily detected by the magnetism-detective device 150, the shape of the magnet 142 is deigned to be an arc in this embodiment, herein the arc of the magnet is between about half to two-thirds of a circle, thus when the carafe 140 being placed in the cavity 114 of the supporting device 110, although the handle 140i of the carafe 140 is not dead against the opening 116 of the cavity 114, there being a little rotation-offset, but for that the arc of the magnet 142 of the carafe 140 is long enough, the magnetism-detecting device 150 still can detect the magnet 142 and that transmit a signal to control device 160. It is worth mentioning that the shape of the magnet 142 of the present invention is not limited to be the arc structure, it can also be annular, if only the arc of the magnet 142 is long enough to be detected by the magnetism device 150 when the insulated carafe 140 being placed into the carafe-contained cavity 114 of the coffee maker 100 from various angles via the opening 116 of the coffee maker 100.

In summary, the structural character of the coffee maker with the carafe-detected function of the present invention is that mounting the heating device under the warming plate of the supporting device, thus the heating device not only can provide the needed hot water for brewing coffee for the brewing device, but also can heat the warming plate selectively through the controlling of the control device so as to heat the carafe on the warming plate. Furthermore, the coffee maker has a magnet-detection device, and the carafe has an arc magnet, when the carafe is placed on the coffee maker, the magnet-detection device can detect the magnet of the insulated carafe and transmit a signal to the control device, then the control device will control the heating device mounted under the warming plate to power-off. So compared with the other coffee makers, the structure of the present invention can reduce the cost effectively and solve the problem of the inconvenience in cleaning the coffee maker and the problem of limited designs, thus to meet the actual requirement of the users.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with detailed description, but rather by the claims appended hereto.

We claim:

1. A coffee maker, at least comprising:
a supporting device for supporting a carafe;
a brewing device for brewing coffee, mounted on the supporting device;
a heating device for providing the hot water for brewing the coffee for the brewing device, which can heat the carafe supported by the supporting device selectively;
an insulated carafe containing magnet mounted on the supporting device detachably;
a magnetism-detecting device for detecting the carafe supported by the supporting device whether it contains magnet or not; and
a control device connected to the magnetism-detect device and the heating device used to judge to heat or not to heat the carafe supported by the supporting device based on the detecting result of the magnetism-detecting device.

2. The coffee maker according to claim 1, further comprising at least an uninsulated carafe without magnetism, which mounted on the supporting device detachably.

3. The coffee maker according to claim 1, wherein the supporting device has a warming plate for supporting the carafe.

4. The coffee maker according to claim 3, wherein the heating device is under the warming plate.

5. The coffee maker according to claim 4, wherein the supporting device has a cavity for containing the carafe, and the width of the opening of the cavity is between about half to two-thirds of a circle.

6. The coffee maker according to claim 2, wherein the heating device mounted in the supporting device.

7. The coffee maker according to claim 6, wherein the shape of the magnet is an arc.

8. The coffee maker according to claim 7, wherein the arc of the magnet is between about half to two-thirds of a circle.

9. The coffee maker according to claim 8, wherein a thermostat is mounted on the side of the heating device.

10. The coffee maker according to claim 7, wherein the magnet shape is arc.
